(19) United States
(12) Patent Application Publication
(10) Pub. No.: US 2014/0089300 A1
(43) Pub. Date: Mar. 27, 2014

(54) METHOD AND SYSTEM FOR INPUTTING INFORMATION IN MOBILE TERMINAL AS WELL AS MOBILE TERMINAL

(71) Applicants: Chuan Peng, Shenzhen (CN); Jun Zhang, Shenzhen (CN); Difei Chen, Shenzhen (CN); Junfeng Zhao, Shenzhen (CN); Yaohui Yu, Shenzhen (CN); Xu Zhang, Shenzhen (CN); Lei Du, Shenzhen (CN)

(72) Inventors: Chuan Peng, Shenzhen (CN); Jun Zhang, Shenzhen (CN); Difei Chen, Shenzhen (CN); Junfeng Zhao, Shenzhen (CN); Yaohui Yu, Shenzhen (CN); Xu Zhang, Shenzhen (CN); Lei Du, Shenzhen (CN)

(73) Assignee: TENCENT TECHNOLOGY (SHENZHEN) COMPANY LIMITED, Shenzhen, Guangdong (CN)

(21) Appl. No.: 14/119,132

(22) PCT Filed: May 11, 2012
(86) PCT No.: PCT/CN2012/075346

§ 371 Date: Nov. 20, 2013

(30) Foreign Application Priority Data
May 20, 2011 (CN) 201110131797.5

(51) Int. Cl. G06F 17/30

(52) U.S. Cl. CPC G06F 17/30554
USPC 707/722

(57) ABSTRACT

The present disclosure discloses a method and system for inputting information in mobile terminal as well as terminal. The method includes: the mobile terminal sending a request (101) for acquiring listening list to a server; the mobile terminal receiving user information in the listening list returned by the server; the mobile terminal receiving and storing the user information, matching a character input by a user with the user information, displaying a matching result, and determining input information (103) according to selection of the user. By applying the present disclosure, the traffic of mobile communication can be saved and the success rate of information transmission can be increased.

This application claims the benefit of priority from Chinese Patent Application, No. 201110131797.5, entitled “METHOD AND SYSTEM FOR INPUTTING INFORMATION IN MOBILE TERMINAL AS WELL AS MOBILE TERMINAL” and filed on May 20, 2011, the entire contents of which are hereby incorporated by reference.

### FIELD OF THE INVENTION

The present disclosure relates to mobile communication technology, and more particularly to a method and system for inputting information in mobile terminal as well as mobile terminal.

### BACKGROUND ART

Microblog, which is the abbreviation of the miniature blog, is based on the traditional internet or wireless internet, to provide users with blog service including publishing short text and allowing others to read.

In microblog service, each microblog user has a microblog user name which is a universally unique identifier of the user in the microblog service and is used to mark an independent address of each microblog user's microblog homepage. Different users have different microblog user names. The microblog user name usually only allows English characters and Arabic numerals.

In addition to the microblog user name, each microblog user further has a microblog user nickname which is a name of the microblog user used in the microblog service. Different microblog users can have the same nickname. The microblog user nickname allows both of English characters and Chinese characters.

Broadcasting is an information transmission method widely used in the microblog services. Each piece of information in the microblog can be called as a broadcast message. Relative to the sender of each broadcast message, the receiver can be called as an audience of the sender, and the sender is equivalent to a person to whom the receiver listens. The server side stores “my audience list” and “my listening list” for each user. The server broadcasts a message sent from a user to each user in the user's “my audience list”, and broadcasts a message sent from each user in the user's “my listening list” to the user.

Broadcasting can be divided into dialogue, broadcast, and other forms. “Mention me” is also a form of broadcasting, and is configured to highlight display corresponding broadcast message. Specifically, for any user A, when other user sends a broadcast message mentioned the user A or other user sends a broadcast message to the user A, the broadcast message will appear in an information category “mention me” of the user A.

At present, if one microblog user wants to send a broadcast message to other user, the following form is generally used to input information in terminal: message content@ user name of other user. For example, if the user A wants to send message content 1 to the user B, then information that the user A needs to input in a terminal is: message content 1@ user B. When the microblog user wants to send a broadcast message to several other users, the microblog user needs to successively input names of the other users after the character @.

Since user names of microblog users adopt the form of English characters and Arabic numerals and different microblog users have different user names, thus, when one microblog user wants to send a broadcast message to other user, broadcast message transmission failure or error due to wrong user name input by the user is likely to occur. Particularly when the microblog user wants to send a broadcast message to several other users, since the user needs to input user names of several microblog users, thus, the probability that the user inputs wrong user names is also increased.

In order to avoid broadcast message transmission failure or error due to wrong user name input by the user in the microblog terminal, in a microblog system based on traditional internet, the following method can be adopted to input information in the microblog terminal.

Step 1: after a personal computer (PC) as a microblog terminal receives a character @ input by a user, sending in real time a character input by the user after the character @ to a server side.

Step 2: the server searching in the user's “my audience list”, and sending user names and/or nicknames in the list which match the character to the PC.

Step 3: the PC displaying the user names and/or nicknames sent from the server for the user to select, and determining user names and/or nicknames selected by the user as input information.

In a microblog system based on wireless internet, a microblog terminal is a mobile terminal such as a phone, etc. If the mobile terminal uses the same information input method as the PC when determining input microblog information, it is needed to perform frequent information interaction between the mobile terminal and the server. The frequent information interaction occupies a lot of traffic of mobile communication, resulting in that mobile communication resources become more strained.

Further, due to instability of network environment in wireless internet, frequent information interaction between the mobile terminal and the server can also reduce information transmission performance, for example, easily resulting in loss of information and large input delay, and the success rate of information transmission is low.

### SUMMARY

In view of this, one example of the present disclosure provides a method and system for inputting information in mobile terminal as well as a mobile terminal, so as to save traffic of mobile communication.

In order to achieve the above object, the technical solution of the present disclosure is specifically implemented as follows:

A method for inputting information in mobile terminal includes:

a mobile terminal sending a request for acquiring listening list to a server;

after the server receives the request, the server sending user information in a corresponding listening list to the mobile terminal;

the mobile terminal receiving and storing the user information, matching a character input by a user with the user information, displaying a matching result, and determining input information according to selection of the user.

A system for inputting information in mobile terminal, the system includes a mobile terminal and a server; wherein

the mobile terminal sends a request for acquiring listening list to the server;

after the server receives the request, the server sends user information of a corresponding listening list to the mobile terminal;

the mobile terminal receives and stores the user information, matches a character input by a user with the user information, displays a matching result, and determines input information according to selection of the user.

A mobile terminal includes a communication module, a storage module and a query module; wherein

the communication module is configured to send a request for acquiring listening list to a server after receiving a microblog service logon request for the first time, receive user information returned by the server and store the user information in the storage module;

the storage module is configured to store the user information returned by the server;

the query module is configured to receive an instruction for finding user information, match a character input by the user with the user information stored in the storage module, display a matching result and determine input information according to selection of the user.

It can be seen from the above technical solution, in the present disclosure, a mobile terminal sends a request for acquiring listening list to a server; the server sends user information in a corresponding listening list to the mobile terminal; the mobile terminal stores the user information in the local, matches a character input by a user with the user information and determines input information according to the user's selection of the matching result. In the present disclosure, after the server sends user information in a listening list to the mobile terminal, since the mobile terminal stores the user information in the local, thus it is not needed to perform frequent information interaction between the mobile terminal and the server; compared with performing frequent information interaction, the traffic of mobile communication can be saved. In other words, in the whole user's inputting process, the mobile terminal only needs to match information input by the user with the user information data stored in the mobile terminal, and does not involve any interaction operation with the server and the network layer, thereby avoiding overloading the performance of the mobile terminal caused by continuously connecting to the network and querying user information as well as potential risks of mobile data traffic overrun.

### BRIEF DESCRIPTION OF THE DRAWINGS

FIG. 1 is a flowchart of a method for inputting information in mobile terminal according to the present disclosure;

FIG. 2 is a diagram of a system for inputting information in mobile terminal according to the present disclosure; and

FIG. 3 is a diagram of a mobile terminal according to the present disclosure.

### DETAILED DESCRIPTION

To make the technical solution and advantages of the present disclosure more clear, the present disclosure is hereinafter described in detail with reference to examples and the accompanying drawings.

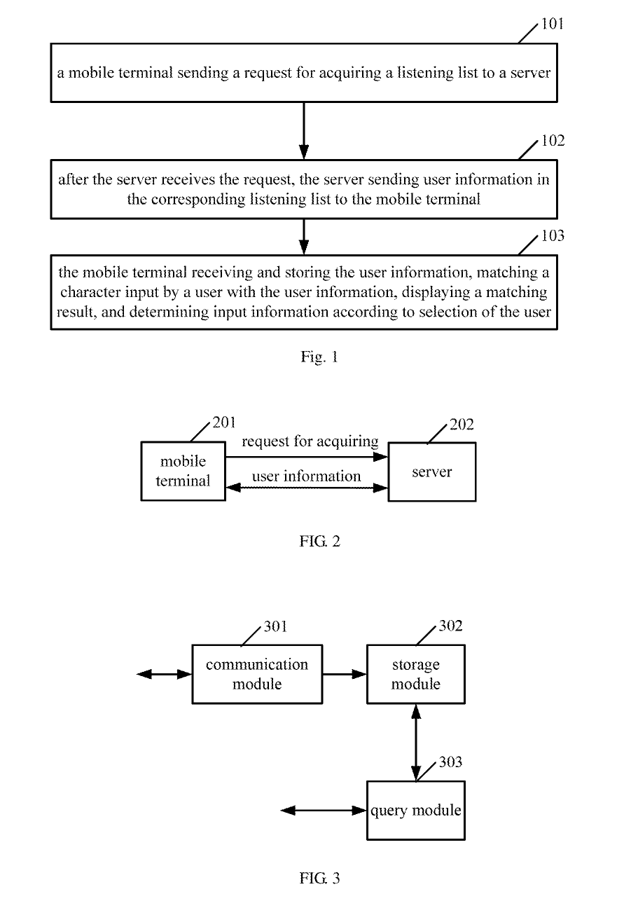

FIG. 1 is a flowchart of a method for inputting information in mobile terminal according to the present disclosure.

As shown in FIG. 1, the method includes:

Step 101: a mobile terminal sending a request for acquiring listening list to a server.

Step 102: after the server receives the request, the server sending user information in a corresponding listening list to the mobile terminal.

As an implementation way, in this step, amount of user information returned each time by the server to the mobile terminal, is not greater than a predetermined number, thereby avoiding information transmission failure caused by large amount of data, so as to further improve success rate of information transmission.

In this step, if the amount of the user information in the listening list is greater than the predetermined number, the server sends in two or more batches the user information in the listening list to the mobile terminal, thus, the large amount of data can be sent in batches so as to reduce amount of date sent in each time, so that the success rate of data transmission can be improved by reducing amount of date sent each time in a mobile communication network environment of poor stability.

The predetermined number can be determined based on experience or statistical results. For example, if a number of frequent contacted users in a listening list of most microblog users is not greater than 100, the predetermined number can be set to be 100. Details about how to set the predetermined number and specific value of the predetermined number are not limited here.

Step 103: the mobile terminal receiving and storing the user information, matching a character input by a user with the user information, displaying a matching result, and determining input information according to selection of the user.

In the method shown in FIG. 1, the server can return user information to the mobile terminal according to frequencies of user information used by the mobile terminal. For example, according to a descending order of the frequencies of user information used by the mobile terminal, corresponding user information can be selected from the listening list and sent to the mobile terminal. The mobile terminal can also display in sequence user information which matches with the character input by the user, according to the descending order of the frequencies of user information used by the mobile terminal.

In the method shown in FIG. 1, the mobile terminal can send the request for acquiring listening list to the server after the mobile terminal receives a microblog service logon request for the first time, and sends only once the request for acquiring listening list before existing this logon. After the server receives the request for acquiring listening list, the server sends in one batch or more batches the user information in the corresponding listening list to the mobile terminal. Since the mobile terminal sends only once the request for acquiring listening list before existing this logon, thus, compared with frequently interacting with the server in the related art, the traffic of mobile communication can be saved.

In order to be able to ensure real-time performance of the user information in the listening list stored in the mobile terminal side while saving the traffic of mobile communication, according to the present disclosure, the mobile terminal can send the request for acquiring listening list to the server after the mobile terminal receives a microblog service logon request for the first time in each predetermined length of time period, and the mobile terminal sends only once the request for acquiring listening list before existing this first logon. The mobile terminal updates user information in the listening list stored locally in the mobile terminal according to user information in the listening list returned by the server.

In the server side, user name information and user nickname information of each microblog user are separately stored, respectively. For example, the user name information is stored in a user name list, and the user nickname information is stored in a user nickname list. In order to improve the speed at which the mobile terminal determines input information, the present disclosure provides: the server puts user name information and user nickname information of each user in the listening list into a character string, takes the character string as user information of each user and sends the character string to the mobile terminal. The mobile terminal stores the character string. After one user input the character @, the mobile terminal matches a character continued to be input by the user with the character string. Since the character string includes both of the user name information and the user nickname information of the microblog user, thus, the mobile terminal can match the character input by the user with the user name information of the microblog user and match the character input by the user with the user nickname of the microblog user through one matching operation on the character string. This can improve matching speed, thereby improving the speed at which the mobile terminal determines input information.

Further, since the character string includes both of the user name information and the user nickname information of the microblog user, thus, it is not needed to set separate storage entries for the user name information and the user nickname information, respectively, this can also save storage space.

The matching of the present disclosure can be English character match, number match and/or Chinese character match.

According to the above method, the present disclosure also provides a corresponding inputting system, details of which refer to FIG. 2.

FIG. 2 is a diagram of a system for inputting information in mobile terminal according to the present disclosure.

As shown in FIG. 2, the system includes a mobile terminal 201 and a server 202.

The mobile terminal 201 sends a request for acquiring listening list to the server 202.

After the server 202 receives the request, the server 202 sends user information of the corresponding listening list to the mobile terminal 201.

The mobile terminal 201 receives and stores the user information, matches a character input by a user with the user information, displays a matching result, and determines input information according to selection of the user.

As an implementation way, amount of user information returned each time by the server 202 to the mobile terminal 201, is not greater than a predetermined number.

If the amount of the user information in the listening list is greater than the predetermined number, the server 202 sends in two or more batches the user information in the listening list to the mobile terminal 201.

After the mobile terminal 201 receives a microblog service logon request for the first time, the mobile terminal 201 can send the request for acquiring listening list to the server 202, and sends only once the request for acquiring listening list before existing this logon.

The mobile terminal 201 can send the request for acquiring listening list to the server 202 after the mobile terminal 201 receives a microblog service logon request for the first time in each predetermined length of time period, and the mobile terminal 201 sends only once the request for acquiring listening list before existing this first logon. The mobile terminal 201 updates user information in the listening list stored locally in the mobile terminal 201 according to user information in the listening list returned by the server 202.

FIG. 3 is a diagram of a mobile terminal according to the present disclosure.

As shown in FIG. 3, the mobile terminal includes a communication module 301, a storage module 302 and a query module 303.

The communication module 301 is configured to send a request for acquiring listening list to a server, and receive user information of a listening list returned by the server.

The storage module 302 is configured to store the user information.

The query module 303 is configured to match a character input by the user with the user information stored in the storage module 302, display a matching result and determine input information according to selection of the user.

The communication module 301 is configured to, after receiving a microblog service logon request for the first time, send the request for acquiring listening list to the server, receive user information returned by the server and store the user information in the storage module 302.

The storage module 302 is configured to store the user information returned by the server.

The query module 303 is configured to receive an instruction for finding user information, match a character input by the user with the user information stored in the storage module 302, display a matching result and determine input information according to selection of the user.

The communication module 301 is configured to, after receiving a microblog service logon request for the first time in each predetermined length of time period, send the request for acquiring listening list to the server and send only once the request for acquiring listening list before existing this first logon.

The storage module 302 is configured to update user information in the locally stored listening list according to user information in the listening list returned by the server.

As an implementation way, amount of user information returned each time by the server is not greater than a predetermined number.

At present, in microblog service, the instruction for finding user information usually is the character @ input by the user.

The storage module 302 can store a character string composed of user name information and user nickname information of each microblog user. The query module 303 can match the character input by the user with the character string in the storage module 302 and determines input information according to the user's selection of the matching result.

Through storing the character string composed of user name information and user nickname information of each microblog user, using the query module 303 to perform matching search for the character input by the user, compared with separately storing user name information and user nickname information, respectively, this can reduce the complexity of the mobile matching search performed by the mobile terminal and can also improve search speed.

The above method, system and apparatus can be applied to all scenes of inputting “@ user name” in microblog client, for example, microblog client sending a broadcast message, making a dialogue with other microblog client, sending private message, and so on.

In short, the present disclosure fully considers two factors including mobile communication network data traffic restrictions and performance restrictions of the mobile terminal itself, achieves inputting information in the mobile terminal and improves success rate of information input.

The foregoing are only preferred embodiments of the present disclosure, and are not used to limit the present disclosure. Any modification, equivalent replacement, or improvement made without departing from the spirit and principle of the present disclosure should fall within the scope of the present disclosure.

1. A method for inputting information in mobile terminal, comprising:
a mobile terminal sending a request for acquiring listening list to a server;
the mobile terminal receiving user information in a listening list returned by the server;
the mobile terminal receiving and storing the user information, matching a character input by a user with the user information, displaying a matching result, and determining input information according to selection of the user;
wherein the mobile terminal sending a request for acquiring listening list to a server comprises:
the mobile terminal sending the request for acquiring listening list to the server after the mobile terminal receives a microblog service logon request for the first time, and sending only once the request for acquiring listening list before existing the logon.

2. The method of claim 1, wherein
amount of the user information returned each time by the server is not greater than a predetermined number.

3. The method of claim 1, wherein the mobile terminal receiving user information in a listening list returned by the server comprises:
the mobile terminal receiving the user information in the listening list which is returned by the server in two or more batches, if the amount of the user information in the listening list is greater than the predetermined number.

4. (canceled)

5. The method of claim 1, wherein
the mobile terminal sending the request for acquiring listening list to the server after the mobile terminal receives the microblog service logon request for the first time in each predetermined length of time period, and sending only once the request for acquiring listening list before existing the first logon;
the mobile terminal updating user information in a listening list stored locally in the mobile terminal according to the user information in the listening list returned by the server.

6. The method of claim 1, wherein the mobile terminal receiving user information in a listening list returned by the server comprises:
the mobile terminal receiving a character string which is returned by the server and is taken as user information of users; wherein the character string is composed of user name information and user nickname information of each user in the listening list returned by the server.

7. A mobile terminal comprising a communication module, a storage module and a query module; wherein
the communication module is configured to send a request for acquiring listening list to a server, and receive user information of a listening list returned by the server;
the storage module is configured to store the user information;
the query module is configured to match a character input by a user with the user information stored in the storage module, display a matching result and determine input information according to selection of the user;
wherein the communication module is configured to, after receiving a microblog service logon request for the first time, send the request for acquiring listening list to the server, and send only once the request for acquiring listening list before existing the logon.

8. The mobile terminal of claim 7, wherein
the storage module is configured to store a character string composed of user name information and user nickname information of each user;
the query module is configured to match the character input by the user with the character string stored in the storage module, and determine input information according to the user's selection of the matching result.

9-13. (canceled)

14. A mobile terminal comprising a communication module, a storage module and a query module; wherein
the communication module is configured to send a request for acquiring listening list to a server, and receive user information of a listening list returned by the server;
the storage module is configured to store the user information;
the query module is configured to match a character input by a user with the user information stored in the storage module, display a matching result and determine input information according to selection of the user;
wherein the communication module is configured to, after receiving a microblog service logon request for the first time in each predetermined length of time period, send the request for acquiring listening list to the server, and send only once the request for acquiring listening list before existing the first logon;
the storage module is configured to update user information in a locally stored listening list according to the user information in the listening list returned by the server.
